(19) United States
(12) Patent Application Publication
(10) Pub. No.: US 2026/0242121 A1
(43) Pub. Date: Aug. 20, 2026

(54) STACKING SPACER FOR MOBILE PLATFORMS

(71) Applicant: Swift Beat, LLC, Menlo Park, CA (US)

(72) Inventors: Christian Johan Owen HANDLEY, San Francisco, CA (US); Michael Shane WILKERSON, Summerville, SC (US); Robert Donald VOCKE, III, San Jose, CA (US)

(21) Appl. No.: 19/542,624

(22) Filed: Feb. 17, 2026

Related U.S. Application Data
(60) Provisional application No. 63/760,032, filed on Feb. 18, 2025.
(60) Provisional application No. 63/803,081, filed on May 9, 2025.
(60) Provisional application No. 63/807,413, filed on May 16, 2025.
(60) Provisional application No. 63/815,810, filed on Jun. 1, 2025.
(60) Provisional application No. 63/854,392, filed on Jul. 30, 2025.
(60) Provisional application No. 63/910,760, filed on Nov. 3, 2025.

(51) Int. Cl. B65D 85/02

(52) U.S. Cl. CPC B65D 85/02

(57) ABSTRACT

A stacking spacer for a first mobile platform includes a body including a length extending from a first end portion to a second end portion. The length of the body is configured to space the first mobile platform apart from a second mobile platform when the first and second mobile platforms are stacked together. The first end portion includes a first mating feature that is configured to mate with another stacking spacer of the second mobile platform. The body includes a mount configured to secure the body to the first mobile platform. The body includes a guide segment that extends along the length of the body. The guide segment is configured to receive a guide element therein.

### CROSS-REFERENCE TO RELATED APPLICATIONS

This non-provisional utility application claims priority to provisional patent application no. 63/760,032, entitled “STACKING SPACER FOR MOBILE PLATFORMS” and filed on Feb. 18, 2025, provisional patent application no. 63/807,413, entitled “LAUNCHING CONTAINER USING SUPPORTS FOR MOBILE PLATFORMS” and filed on May 16, 2025, provisional patent application no. 63/803,081, entitled “MOBILE PLATFORM DEPLOYMENT METHOD AND SYSTEM” and filed on May 9, 2025, provisional patent application no. 63/815,810, entitled “LAUNCHING CONTAINER ASSEMBLY FOR MOBILE PLATFORMS” and filed on Jun. 1, 2025, provisional patent application no. 63/854,392, entitled “DUAL-PURPOSE BOOT AND METHOD OF MANUFACTURE” and filed on Jul. 30, 2025, provisional patent application no. 63/960,687, entitled “CONTAINER ASSEMBLY WITH SECURING MECHANISM” and filed on Jan. 14, 2026, provisional patent application no. 63/910,760, entitled “MOBILE PLATFORM STACKING ASSEMBLY” and filed on Nov. 3, 2025, each of which is incorporated herein in its entirety by reference.

### BACKGROUND

Existing methods and systems for transporting and deploying mobile platforms exhibit a variety of technical limitations and disadvantages.

### SUMMARY

In one aspect, a stacking spacer for a first mobile platform includes a body including a length extending from a first end portion to a second end portion. The length of the body is configured to space the first mobile platform apart from a second mobile platform when the first and second mobile platforms are stacked together. The first end portion includes a first mating feature that is configured to mate with another stacking spacer of the second mobile platform. The body includes a mount configured to secure the body to the first mobile platform. The body includes a guide segment that extends along the length of the body. The guide segment is configured to receive a guide element therein.

In another aspect, a stacking spacer for a first mobile platform includes a body including a guide segment that extends along a length of the body. The guide segment is configured to receive a guide element therein. The body includes a mount configured to secure the body to the first mobile platform. The stacking spacer includes a leg configured to support at least a portion of the first mobile platform when the first mobile platform is at rest. The leg extends a length from a first end portion to a second end portion. The first end includes a first mating feature that is configured to mate with a second mobile platform. The length of the leg is configured to space the first mobile platform apart from the second mobile platform when the first and second mobile platforms are stacked together.

In another aspect, a first mobile platform includes a segment extending from a first side to a second side. The segment is configured to space the first mobile platform from a second mobile platform when the first and second mobile platforms are stacked together. The first side includes a first mating feature that is configured to mate with the second mobile platform.

### BRIEF DESCRIPTION OF THE DRAWINGS

FIG. 1 is a perspective view illustrating a stack of mobile platforms including a spacer assembly according to an implementation.

FIG. 2 is an elevational view of a portion of the stack shown in FIG. 1 illustrating the spacer assembly shown in FIG. 1 according to an implementation.

FIG. 3 is a perspective view of a portion of the stack shown in FIG. 1 illustrating the spacer assembly shown in FIG. 1 according to an implementation.

FIG. 4 illustrates elevational views of an example of the stack shown in FIG. 1 being held by an exemplary carrying pack according to an implementation.

FIG. 5 is a perspective view illustrating a stacking spacer of the spacer assembly shown in FIG. 1 according to an implementation.

FIG. 6 is a perspective view of a portion of the stack shown in FIG. 1 illustrating the spacer assembly shown in FIG. 1 according to an implementation.

FIG. 7 is an elevational view illustrating a mobile platform including a spacer assembly according to an implementation.

FIG. 8 is an elevational view illustrating a mobile platform including a spacer assembly according to an implementation.

FIG. 9 is a perspective view illustrating a stacking spacer of the spacer assembly shown in FIG. 8 according to an implementation.

FIG. 10 is a perspective view illustrating a portion of a stack including the mobile platform shown in FIG. 8 according to an implementation.

FIG. 11 is a perspective view illustrating a mobile platform including a spacer assembly having a leg according to an implementation.

FIG. 12 is a perspective view illustrating a stack of mobile platforms including a spacer assembly according to an implementation.

FIG. 13 is a perspective view of a portion of a mobile platform illustrating a stacking spacer body according to an implementation.

### DETAILED DESCRIPTION

Existing methods and systems for handling, transporting, and deploying mobile platforms exhibit a variety of technical limitations and disadvantages. For example, existing systems may suffer from excessive movement of a stack of mobile platforms and/or excessive movement between mobile platforms within the stack (e.g., during transit, handling, and/or deployment operations, etc.). Such excessive movement of the mobile platforms may damage components of the system such as guide elements, the mobile platforms, and/or the like, for example via warping, collisions between components, and/or component failures, and/or the like. Moreover, existing transport and/or deployment systems suffer from misalignment issues between mobile platforms within a stack that can prevent proper deployment and/or create structural stress on components of the system. For example, mobile platforms within a stack can be prone to lateral displacement when subjected to shear forces, for example during transport, handling, and/or deployment. Individual mobile platforms can thus shift out of position within the stack, resulting in misalignment between the stacked mobile platforms, collisions between components, warping, and/or the like. Moreover, and for example, existing systems may suffer from inconsistent placement of the mobile platforms within a stack that results in misalignment. Misalignment between mobile platforms within a stack not only undermines stacking efficiency but also heightens the potential for impact damage during movement (e.g., transport, handling, etc.) and/or deployment.

In contrast, aspects of the disclosure provide a stacking spacer and/or a segment for stacking, transporting, and/or launching mobile platforms. In some examples, the stacking spacer and/or segment is integrated with one or more guide elements, for example to prevent or reduce misalignment and/or damage during transport, handling, and/or deployment. In addition or alternative to providing guiding functions, the guide elements may provide alignment functions, stability functions, and/or the like. The stacking spacer and/or segment, which may include elements such as one or more extensions for secure attachment to a mobile platform, optionally features alignment elements (e.g., mating features, etc.) to facilitate higher precision stacking, for example to prevent or reduce misalignment and/or damage during transport, handling, and/or deployment. Aspects of the disclosure support synchronized and/or sequential mobile platform deployment. Aspects of the disclosure enable post-launch retention and/or detachment of the stacking spacer and/or segment based on desired flight dynamics. In some examples, the guide elements incorporate functionalities beyond alignment, stability, and/or guidance, such as, but not limited to, data transfer, communication support, power conduits, and/or the like.

Examples of applications of the subject matter disclosed herein include, but are not limited to, agricultural monitoring and management, disaster response and/or recovery, environmental conservation and/or monitoring, urban infrastructure inspection, scientific research and/or mapping, telecommunication and/or network deployment, logistical support and/or delivery, construction and/or maintenance, and/or the like.

Examples of agricultural monitoring and/or management applications include enabling more rapid deployment of mobile platforms for crop monitoring, pest control, irrigation management across relatively expansive farmland, and/or the like. For example, the mobile platforms can be deployed sequentially or simultaneously to cover larger areas, for example providing data on plant health and/or soil conditions.

An example of a disaster response and/or recovery application includes deploying mobile platforms in emergency situations from the stacked configuration, for example to assess damage, deliver aid materials, search for survivors, and/or the like. The quicker launch capability provided by aspects of the disclosure enables more immediate response and/or real-time data collection to support recovery efforts.

Environmental conservation and/or monitoring applications include equipping mobile platforms with sensors to monitor wildlife, track deforestation, inspect remote ecosystems, and/or the like, which for example may streamline environmental surveys and/or conservation efforts by facilitating more rapid data collection across relatively large and/or varied terrains.

An urban infrastructure inspection example includes relatively efficient inspection of bridges, power lines, other critical infrastructure within urban environments, and/or the like. Multiple mobile platforms can be launched to cover relatively large and/or relatively complex structures, for example ensuring thorough and/or timely inspection efforts.

In a scientific research and/or mapping application, researchers can use stacked mobile platforms for geospatial mapping, atmospheric sampling, wildlife observation, and/or the like, which may aid in collecting data over relatively extensive and/or relatively difficult-to-access areas, for example enhancing research accuracy and scope.

Telecommunication and/or network deployment applications include, but are not limited to, using mobile platforms to establish temporary communication networks in relatively remote and/or underserved regions, which for example may enable for more rapid setup of relay stations, signal boosters, and/or the like (e.g., facilitating communication and/or connectivity).

Examples of logistical support and/or delivery applications include supporting the distribution of goods in logistics and/or delivery applications (e.g., in relatively crowded and/or relatively difficult-to-reach urban areas, etc.). For example, mobile platforms can be launched in a coordinated sequence to perform delivery tasks more efficiently and/or more reliably.

In a construction and/or maintenance application example, mobile platforms can perform tasks at construction sites such as, but not limited to, surveying, progress monitoring, equipment inspection, and/or the like. The stacked deployment of the mobile platforms enables more efficient management of multiple mobile platform operations on-site, for example aiding in project management and/or maintenance.

Aspects of the disclosure operate in an unconventional manner at least by providing a stacking spacer for a first mobile platform. The stacking spacer includes a body including a length extending from a first end portion to a second end portion. The length of the body is configured to space the first mobile platform apart from a second mobile platform when the first and second mobile platforms are stacked together. The first end portion includes a first mating feature that is configured to mate with another stacking spacer of the second mobile platform. The body includes a mount configured to secure the body to the first mobile platform. The body includes a guide segment that extends along the length of the body. The guide segment is configured to receive a guide element therein.

Aspects of the disclosure operate in an unconventional manner at least by providing a stacking spacer for a first mobile platform. The stacking spacer includes a body including a guide segment that extends along a length of the body. The guide segment is configured to receive a guide element therein. The body includes a mount configured to secure the body to the first mobile platform. The stacking spacer includes a leg configured to support at least a portion of the first mobile platform when the first mobile platform is at rest. The leg extends a length from a first end portion to a second end portion. The first end portion includes a first mating feature that is configured to mate with a second mobile platform. The length of the leg is configured to space the first mobile platform apart from the second mobile platform when the first and second mobile platforms are stacked together.

Aspects of the disclosure operate in an unconventional manner at least by providing a first mobile platform that includes a segment extending from a first side to a second side. The segment is configured to space the first mobile platform from a second mobile platform when the first and second mobile platforms are stacked together. The first side includes a first mating feature that is configured to mate with the second mobile platform.

Example technical solutions to the technical problems disclosed herein include the disclosed stacking spacers and the disclosed segments for stacking, transporting, and launching mobile platforms. The technical solutions of the disclosed stacking spacers and the disclosed segments provide the technical effects of: increasing (e.g., maximizing, etc.) space efficiency; reducing, limiting, and/or eliminating damage; providing structural support for more stable stacking and/or stacks; and/or reducing, limiting, and/or preventing misalignment.

For example, the technical solution of the disclosed stacking spacer and/or segment being integrated with one or more guide elements provides the technical effects of: reducing, limiting, and/or eliminating uncontrolled and/or excessive movement of a stack of mobile platforms and/or between mobile platforms within the stack, for example during transit, handling, and/or deployment operations. The technical solution of the disclosed stacking spacer and/or segment being integrated with the guide element(s) thereby provides the technical effect of reducing, limiting, and/or preventing damage to components such as guide elements, the mobile platforms, and/or the like, for example by reducing, limiting, and/or preventing warping, collisions between components, component failures, and/or the like.

The technical solution of the disclosed stacking spacer and/or segment including alignment elements, for example, provides the technical effects of: reducing, limiting, and/or eliminating uncontrolled and/or excessive movement of a stack of mobile platforms and/or between mobile platforms within the stack, for example during transit, handling, and/or deployment operations. The technical solution of the alignment elements thereby provides the technical effect of reducing, limiting, and/or preventing damage to components such as guide elements, the mobile platforms, and/or the like, for example by reducing, limiting, and/or preventing warping, collisions between components, component failures, and/or the like.

In another example, the disclosed alignment elements of the disclosed stacking spacers and/or segments provide the technical effects of: reducing, limiting, and/or eliminating misalignment issues (e.g., between mobile platforms within a stack, of a stack, etc.), for example during transport, handling, and/or deployment operations. For example, the disclosed alignment elements (e.g., mating features, etc.) reduce, limit, and/or prevent misalignment by: reducing, limiting, and/or preventing lateral displacement of mobile platforms within the stack (e.g., when subjected to shear forces, etc.); providing more consistent placement of mobile platforms within a stack; and/or the like. By reducing, limiting, and/or preventing misalignment, the technical solution of the disclosed alignment elements also provides the technical effect of reducing, limiting, and/or preventing impact damage, for example during movement (e.g., transport, handling, etc.) and/or deployment.

The technical solution of integrating of one or more guide elements with the disclosed stacking spacers and/or segments provides the technical effect of, for example, reducing, limiting, and/or eliminating misalignment issues. For example, the disclosed integration with one or more guide elements reduces, limits, and/or prevents misalignment by: reducing, limiting, and/or preventing lateral displacement of mobile platforms within the stack; providing more consistent placement of mobile platforms within a stack; and/or the like.

In another example, the technical solution of integrating one or more guide elements with the disclosed stacking spacers and/or segments provides the technical effect of, for example, improving performance through enhanced structural integrity, for example during transit, handling, and/or deployment operations.

Another example of the technical solutions and technical effects of the disclosure include the technical solution of providing the disclosed stacking spacers and/or segments and/or the disclosed guide elements with the ability to carry electrical power, electrical signals, optical signals, and/or the like, which for example provides the technical solution of providing the disclosed stacking spacers and/or segments and/or the disclosed guide elements with functionalities beyond alignment, guide, and/or stability (e.g., data transfer, communication support, power conduits, etc.).

In another example, aspects of the disclosure provide the technical solution of post-deployment retention of the stacking spacer and/or segment with the mobile platform (e.g., the stacking spacer and/or segment stays with the mobile platform after the mobile platform has been deployed, etc.), which provides the technical effect of simplifying and improving the efficiency of deployment operations (e.g., decreasing the duration of time required to deploy the mobile platforms, etc.).

Examples of mobile platforms (e.g., mobile platform 106, the mobile platform 706, the mobile platform 806, the mobile platform 1106, the mobile platform 1206, etc.) include, but are not limited to, uncrewed vehicles, uncrewed aerial vehicles (UAVs), aircraft (e.g., rotorcraft, fixed wing aircraft, gliders, airplanes, lighter-than-air craft, balloons, high-altitude balloons, UAVs, etc.), ground vehicles (e.g., land vehicles, automobiles, trucks, cars, electric vehicles, etc.), uncrewed ground vehicles (UGVs), marine vehicles (e.g., boats, ships, etc.), surface vehicles, submersibles, uncrewed marine vehicles (UMVs), uncrewed surface and/or submersible vehicles (USVs), space-based platforms (e.g., cubesats, etc.), suborbital vehicles, vehicles that operate in orbit, platforms carried by an individual (e.g., a backpack and/or other carrying pack, etc.), animals (e.g., a flying animal such as a bird and/or insect, a land animal, a marine animal, etc.), missiles, rockets, uncrewed mobile platforms, autonomous mobile platforms, and/or the like. In some examples, a spacer assembly 100 as next described is used with uncrewed, autonomous mobile platforms.

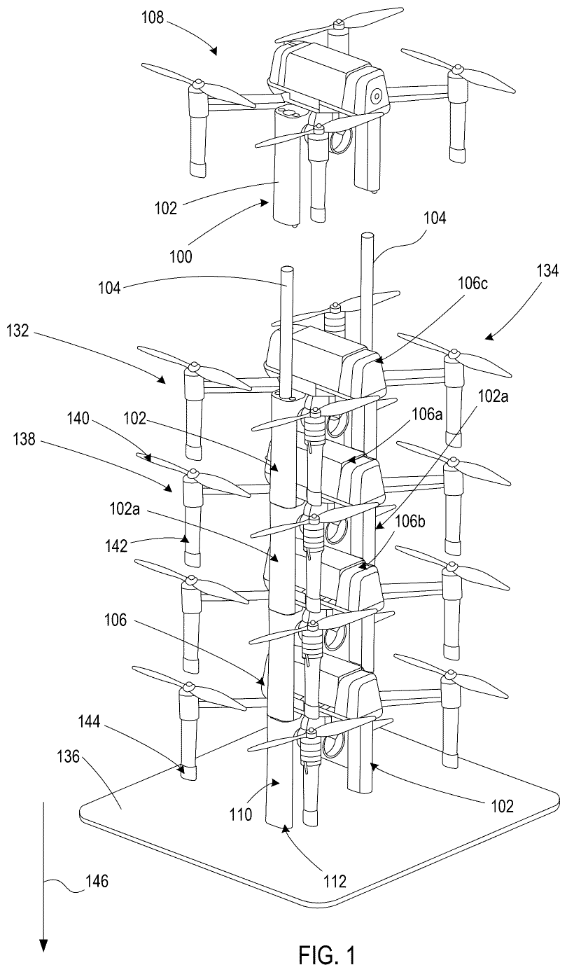

Referring to the figures, FIGS. 1-3 illustrate a spacer assembly 100 for stacking mobile platforms. The spacer assembly 100 includes stacking spacers 102 and a guide element 104. Each stacking spacer 102 is configured to hold (e.g., be mounted to, etc.) a corresponding mobile platform 106 and mate with (e.g., engage in physical contact with, interlock with, etc.) the stacking spacers 102 of adjacent mobile platforms 106 (e.g., above and/or below) within a stack 108 of the mobile platforms 106. The stacking spacers 102 receive the guide element 104 therein, for example to facilitate holding the mobile platforms 106 together within the stack 108. The guide elements 104 are configured to provide guiding, stability, and/or alignment functions. For example, each guide element 104 may be configured to: guide the mobile platforms 106 as the mobile platforms deploy (e.g., launch, etc.), provide stability to the mobile platforms 106 within the stack 108, and/or align the positions of the mobile platforms 106 relative to each other within the stack 108. Each of the mobile platforms 106 may be referred to herein as a “first”, “second”, and/or a “third” mobile platform.

In some examples, there is one stacking spacer 102 for each mobile platform 106. In other examples, there are two stacking spacers 102 for each mobile platform 106, for example symmetrical on each side of the mobile platform 106. Although two are shown, the stack 108 may include any number of the guide elements 104.

In some examples, the mobile platforms 106 are stacked using the spacer assembly 100 for storage and/or transport of the mobile platforms 106. For example, the stack 108 of the mobile platforms 106 may be stored (e.g., within a building or other structure, within a cave and/or other underground area, outside, etc.) for later use. In another example, the stack 108 is loaded onto another mobile platform and transported to another location, for example for deployment of one or more of the mobile platforms 106 at the other location.

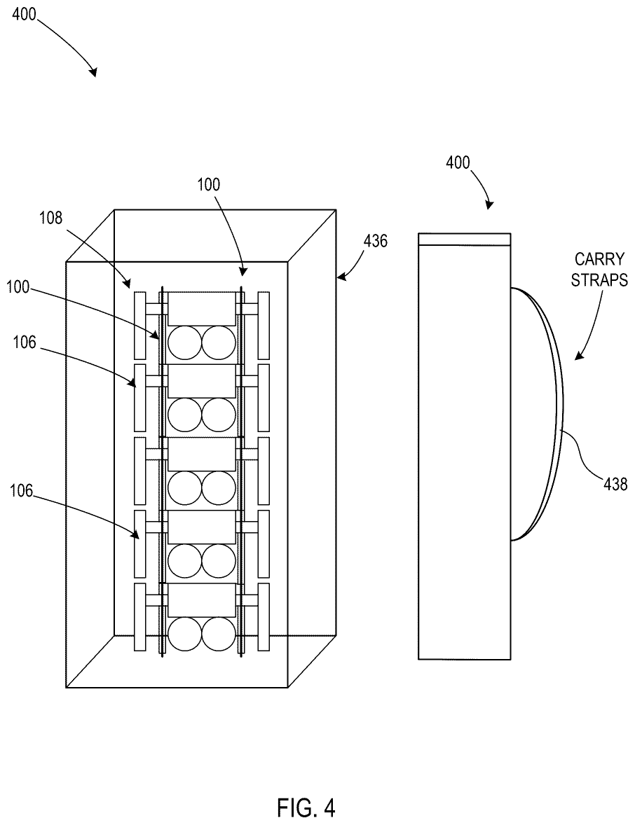

FIG. 4 illustrates one non-limiting example of the stack 108 being held by a carrying pack 400. For example, the carrying pack 400 may include an enclosure 436 that holds the stack 108 of the mobile platforms 106, with the stack 108 including the spacer assembly 100. In some examples, the carrying pack 400 is capable of being carried by an animal and/or a human individual. Optionally, the enclosure 436 includes a construction that is semi-rigid, rigid, soft, flexible, and/or the like. The carrying pack 400 optionally includes a carrying strap 438. In some examples, the carrying pack 400 is configured to be mounted to and/or within another mobile platform (e.g., a car, a truck, a boat, etc.).

Referring now to FIGS. 1-4, one or more of the mobile platforms 106 may, in some examples, be deployed (e.g., launched, etc.) directly from the stack 108. For example, a mobile platform 106 may deploy directly from the stack 108 by moving, under its own power, off the guide element(s) 104. In an exemplary implementation wherein the mobile platforms 106 are UAVs, the mobile platforms 106 may deploy directly from the stack 108 by flying off the guide element(s) 104 under their own power. In some examples, direct deployment of a mobile platform 106 is assisted by facilitating (e.g., initiating, boosting, replacing, etc.) the acceleration of the mobile platform 106 off the guide element(s) 104, for example by spring loading the stacking spacers 102, using a linear motor device (e.g., a rail gun, etc.), using a catapult (e.g., a steam catapult, a mechanical catapult, etc.), and/or the like. In some examples, one or more of the mobile platforms 106 is removed from the stack before being deployed, for example manually, automatically, autonomously, and/or the like.

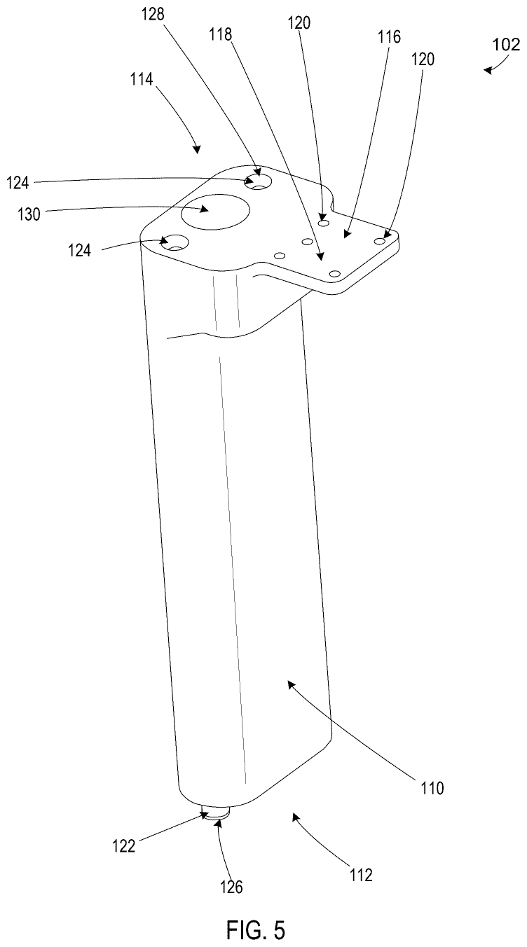

Referring now to FIG. 5, the stacking spacer 102 includes a body 110 extending a length from an end portion 112 to an end portion 114. As shown and described herein, the length of the body 110 is configured (e.g., selected, etc.) to space the corresponding mobile platform 106 apart from an adjacent mobile platform 106 within the stack 108. In an exemplary implementation, and for example as shown in FIGS. 1-3, the stack 108 is approximately vertical such that the length of the body 110 spaces a mobile platform 106a apart from an adjacent mobile platform 106b that is positioned below the mobile platform 106a within the stack 108. In other implementations, the stack 108 may additionally or alternatively extend approximately horizontal and/or an at oblique angle. Each of the end portion 112 and the end portion 114 may be referred to herein as a “first” and/or a “second” end.

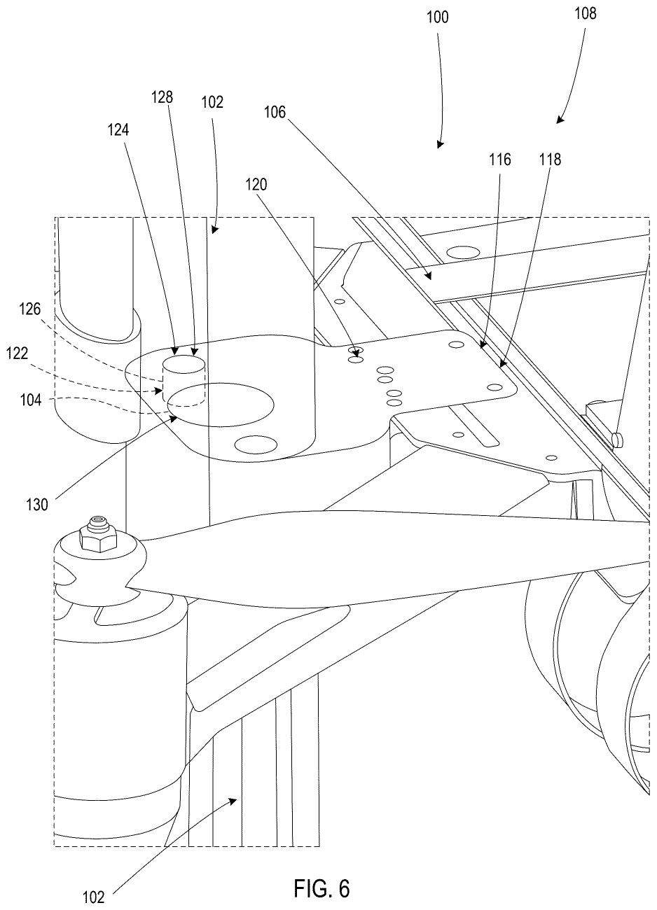

The body 110 of the stacking spacer 102 includes a mount 116 that is configured to secure the body 110 to the corresponding mobile platform 106. In an exemplary implementation, the mount 116 includes a platform 118 having one or more mounting openings 120. Exemplary implementations of the openings 120 are configured to receive fasteners therein to secure the body 110 to the corresponding mobile platform 106. In an exemplary implementation, one or more of the openings 120 is configured to receive a threaded fastener therein to secure the body 110 to the corresponding mobile platform 106. However, the mount 116 and/or the openings 120 may additionally or alternatively be configured to mount to the corresponding mobile platform 106 using any other fastener, fit, structure, means, geometry, mechanism, and/or the like. Examples of other fasteners used with the openings 120 and/or otherwise with the mount 116 include, but are not limited to, clips, latches, clamps, c-clamps, bayonet-type fasteners, quarter or half-turn fasteners, springs, spring-loaded fasteners, interference fit fasteners, press-fit fasteners, clearance fit fasteners, snap-fit fasteners, and/or the like. In some examples, the mount 116 (e.g., the platform 118, etc.) mounts to the corresponding mobile platform 106 with an interference, clearance, snap, and/or press-fit. The geometry of the mount 116 and the platform 118 is meant as exemplary and non-limiting. In addition or alternatively to the geometry of the mount 116 and/or the platform 118 shown and/or described herein, the mount 116 may include any other geometry that enables the mount 116 to function as described and/or illustrated herein. In some examples, the mount 116 and/or the platform 118 include a stamped and/or metal structure. Although five are shown, the mount 116 may include any number of the mounting openings 120, each of which may receive any type of fastener therein. The mount 116 is also shown in FIG. 6.

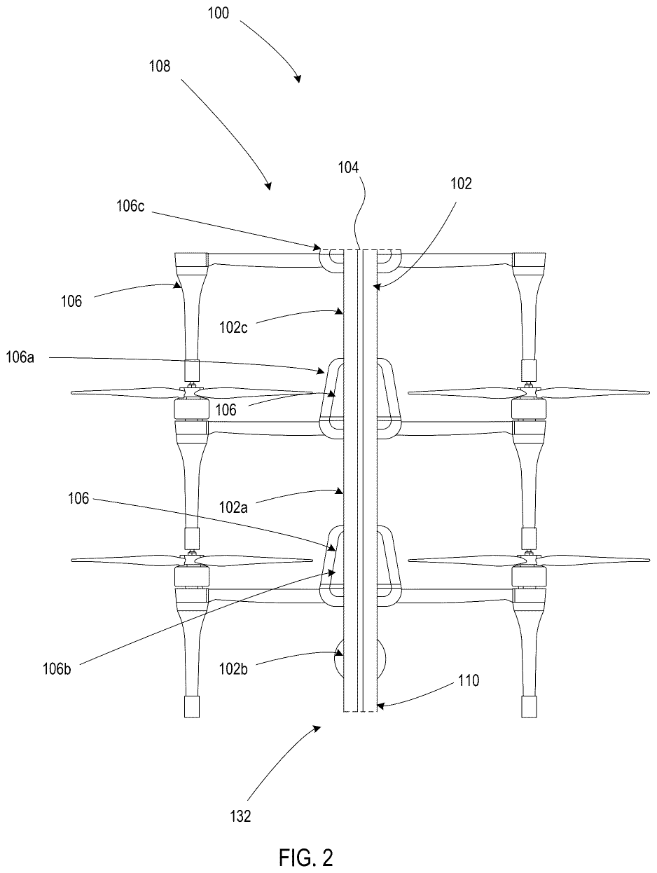

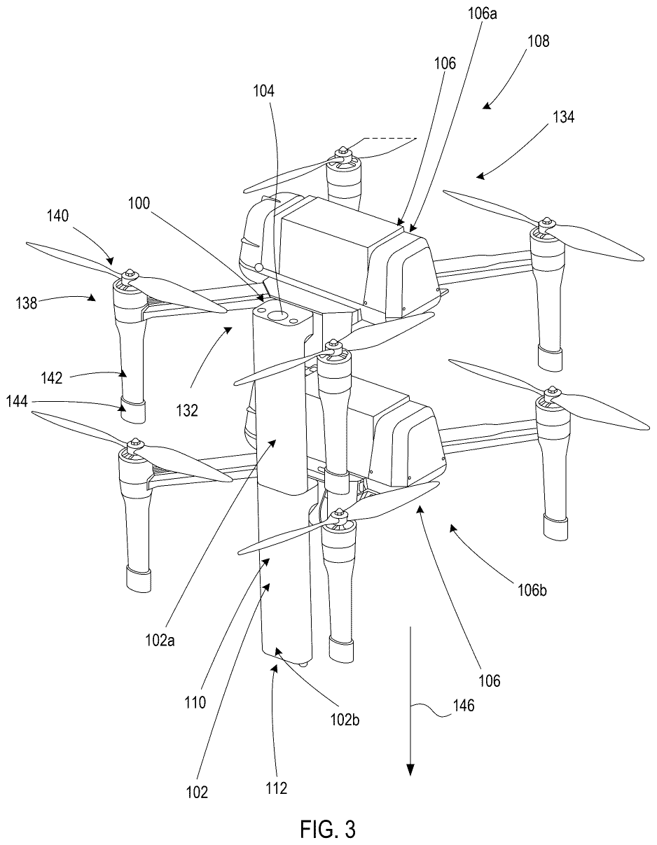

The stacking spacer 102 includes mating features 122 and 124. The mating features 122 and 124 are examples of alignment elements that enable the stacking spacers 102 of adjacently stacked mobile platforms 106 to nest together within the stack 108. In an exemplary implementation, the end portion 112 of the body 110 of the stacking spacer 102 includes a mating feature 122 that is configured to mate with the stacking spacer 102 of an adjacent mobile platform 106 within the stack 108. For example, a stacking spacer 102a (shown in FIGS. 2 and 3) of the mobile platform 106a (shown in FIGS. 1-3) includes an end portion 112 having a mating feature 122 that mates with a corresponding mating feature 124 of an end portion 114 of a stacking spacer 102b (shown in FIGS. 2 and 3) that corresponds to the adjacent mobile platform 106b (shown in FIGS. 1-3). In an exemplary implementation, the stack 108 is approximately vertical such that the adjacent mobile platform 106b is positioned below the mobile platform 106a within the stack 108. The mating feature 122 may be referred to herein as a “first” and/or a “second” mating feature.

In an exemplary implementation, the end portion 114 of the body 110 of the stacking spacer 102 includes a mating feature 124 that is configured to mate with the stacking spacer 102 of an adjacent mobile platform 106 within the stack 108. For example, the end portion 114 of the stacking spacer 102a that corresponds to the mobile platform 106a includes a mating feature 124 that mates with a corresponding mating feature 122 of an end portion 112 of a stacking spacer 102c (shown in FIG. 2) that corresponds to an adjacent mobile platform 106c (shown in FIGS. 1 and 2). In an exemplary implementation of the approximately vertical stack 108, the adjacent mobile platform 106c is positioned above the mobile platform 106a within the stack 108. The mating feature 124 may be referred to herein as a “first” and/or a “second” mating feature.

In an exemplary implementation, the mating feature 122 includes an extension 126 and the mating feature 124 includes a mating opening 128. For example, an extension 126 of the mating feature 122 extends outward at the end portion 112 of the stacking spacer 102a. The extension 126 is configured to be received into a mating opening 128 of the mating feature 124 at the end portion 114 of the stacking spacer 102b that corresponds to adjacent mobile platform 106b. Similarly, and for example, a mating opening 128 of the mating feature 124 at the end portion 114 of the stacking spacer 102a receives an extension 126 of the mating feature 122 at the end portion 112 of the stacking spacer 102c of the mobile platform 106c. In some examples, the mating features 122 and 124 mate together with an interference, clearance, snap, and/or press-fit. The mating opening 128 of the mating feature 124 is also shown in FIG. 6.

Each of the mating features 122 and 124 may additionally or alternatively include any other fastener, fit, structure, means, geometry, mechanism, and/or the like that enables the mating features 122 and 124 to mate together. Examples of other fasteners, fits, structures, means, geometries, mechanisms, and/or the like that may be used to mate the mating features 122 and 124 together include, but are not limited to, clips, latches, clamps, c-clamps, springs, spring-loaded fasteners, the engagement of two or more surfaces in physical contact with each other (e.g., end surfaces, approximately flat surfaces, textured surfaces, complementary surfaces, etc.), and/or the like. The geometries of the extensions 126 and the mating openings 128 are meant as exemplary and non-limiting. In addition or alternatively to the geometry shown and/or described herein, each extension 126 and each mating opening 128 may include any other geometry that enables the mating features 122 and 124 to mate together. Although two are shown, each stacking spacer 102 may include any number of the mating features 122 and any number of the mating features 124.

The body 110 of the stacking spacer 102 includes a guide opening 130 that extends through the body 110 along the length of the body 110. The guide opening 130 is configured to receive the guide element 104 therein. The guide element 104 extends through the guide openings 130 of the stacking spacers 102 of the mobile platforms 106, for example to facilitate holding the mobile platforms 106 together within the stack 108. For example, the guide element 104 may facilitate aligning the mobile platforms 106 as they are stacked, may facilitate holding the stacked mobile platforms 106 in alignment within the stack 108, may facilitate maintaining the structural integrity and/or stability of the stack 108 of the mobile platforms 106 (e.g., as the stack 108 is stored and/or transported, etc.), may facilitate guiding the mobile platforms 106 during deployment (e.g., launch, etc.), and/or the like. In some examples, the guide element 104 facilitates direct deployment of the mobile platforms 106 from the stack 108. For example, the guide element 104 may facilitate direct deployment by transferring force from a mobile platform 106 to a support surface (e.g., a floor, the ground, etc.) upon which the stack 108 is supported. Optionally, the guide element 104 includes a base 136 (shown in FIG. 1) to increase a stability of the guide element 104. The guide opening 130 and guide element 104 are also shown in FIG. 6. The guide opening 130 illustrates a non-limiting example of a guide segment that receives the guide element 104 therein. In addition or alternative to the disclosed opening, the guide opening 130 may include any other opening geometry and/or any other structure that enables the stacking spacer 102 to function as disclosed herein.

In addition or alternatively to the cylindrical geometry shown herein, the guide opening 130 and the guide element 104 may each include any other geometry that enables the guide element 104 to function as described and/or illustrated herein.

In some examples, a parameter (e.g., a geometry, a material, a size, a density, a weight, etc.) and/or configuration of one or more of the stacking spacers 102 and/or the guide element 104 is configured to facilitate the stack 108 being carried by a mobile platform. For example, the guide element 104 may be collapsible (e.g., foldable, telescopically collapsible, etc.) for carrying and/or storage after deployment of the mobile platforms 106. In another example, the geometry of the stacking spacers 102 may be selected such that the stack 108 can be carried and/or otherwise held by a particular mobile platform (e.g., a backpack and/or other carrying pack, a human, an animal, etc.).

Optionally, a containment system (e.g., the carrying pack 400 shown in FIG. 4, etc.) is provided around the stack 108 of the mobile platforms 106. For example, a structure may at least partially surround the stack 108 to provide tipover protection, camouflage, environmental protection (e.g., from dust, moisture, rain, dirt, water, sand, debris, salt water, corrosive materials, etc.), and/or the like. In some examples, the containment system is sealed to prevent infiltration. In some examples, the containment system includes one or more drainage holes. The containment system may have any construction, structure, and/or the like, such as, but not limited to, a construction that is semi-rigid, rigid, soft, flexible, a box, a frame, and/or the like. The containment system may be fabricated from any material(s), such as, but not limited to, wood, a plastic, metal, a composite, and/or the like. In some examples, the containment system is painted and/or at least partially covered with another protective coating, layer, and/or the like (e.g., using a chemically resistant painting and/or protective coating, layer, and/or the like, etc.).

In some examples, the containment system is configured to be mounted (e.g., strapped, detachably mounted, permanently mounted, etc.) to and/or within another mobile platform (e.g., a car, a truck, a boat, etc.). Optionally, the containment system is configured to fall and/or break away, for example for more rapid deployment of the stack of mobile platforms. In some examples, the containment system is configured to be removed from the stack 108 (e.g., using a handle, etc.), for example for more rapid deployment of the stack of mobile platforms. In some examples, one or more of the mobile platforms 106 may be deployed (e.g., launched, etc.) directly from the containment system.

One exemplary implementation of the containment system is an environmental enclosure for maritime uses. For example, the containment system may be used to contain the stack 108 in maritime environments. The containment system, in some examples, is configured to provide the stack 108 with protection from maritime hazards, such as, but not limited to, moisture, salt water, sand, debris, corrosive materials, and/or the like.

In an exemplary implementation, each mobile platform 106 includes two stacking spacers 102 mounted on opposite sides of the mobile platform 106. For example, as is shown in FIGS. 1-3, the mobile platform 106a includes a stacking spacer 102a mounted to a side 132 of the mobile platform 106a and a stacking spacer 102a (not visible in FIGS. 2 and 3) mounted to an opposite side 134 (not shown or labeled in FIG. 2) of the mobile platform 106a. In some examples, providing two stacking spacers 102 mounted on opposite sides of the corresponding mobile platform 106 facilitates balancing the mobile platform 106, for example during flight and/or other movement. In other examples, one or more mobile platforms 106 includes two stacking spacers 102 mounted on sides that are not opposite each other. Although two are shown and described herein, each mobile platform 106 may include any other number of stacking spacers 102 mounted thereto.

In some examples, the guide element 104 is configured to carry electrical power, electrical signals, optical signals, and/or the like. For example, the guide element 104 may be used, in some examples, to deliver electrical power and/or data to and/or from the mobile platforms 106 (e.g., for charging, telemetry, sending mission parameters, configuring mission parameters, programming mission parameters, etc.). Optionally, the guide element 104 functions as an antenna.

In some examples, the stacking spacers 102 are configured to carry electrical power, electrical signals, optical signals, and/or the like. For example, the stacking spacers 102 may be used to deliver electrical power and/or data to and/or from the mobile platforms 106 (e.g., as a remote controller for charging, telemetry, sending flight parameters, configuring mission parameters, programming parameters, etc.). In some examples, the bodies 110 of the stacking spacers 102 are used to carry the electrical power, electrical signals, and/or optical signals, while in other examples the bodies 110 include conduits for holding electrical conductors, optical conductors, and/or the like.

For example, in addition or alternatively to providing stability, spacing, guiding, alignment, and/or the like, the guide element 104 and/or the stacking spacers 102 may serve a variety of other functions, such as, but not limited to, communication array support, power supply conduits, sensor housings, payload interfaces, anti-theft and/or security systems, visual signal displays, data collection integration, and/or the like.

An example of communication array support includes the guide element 104 and/or the stacking spacers 102 incorporating communication elements such as, but not limited to, antennas, signal repeaters, and/or the like. Such integration of communication elements enables the mobile platforms 106 to maintain communication with a central control unit and/or with each other, for example facilitating coordinated operations and/or data sharing during flight. An example of a power supply conduit function includes the guide element 104 and/or the stacking spacers 102 functioning as a conduit for powering mobile platforms 106, for example during preparation, handling, transit, and/or the like. In some examples, this conduit function involves the integration of electrical components and/or connectors within the guide element 104 and/or the stacking spacers 102, for example enabling the transfer of electrical power from a central source to individual mobile platforms 106 for the purpose of charging and/or operating onboard systems prior to launch.

An example of a sensor housing function includes using the guide element 104 and/or the stacking spacers 102 to house sensors that monitor environmental conditions, performance metrics, and/or the like. The sensors may include, but are not limited to, sensors for detecting wind speed, atmospheric pressure, and/or other environmental data for operation and/or navigation of the mobile platforms 106. In a payload interface example, the stacking spacers 102 can integrate mechanisms for carrying and/or deploying payloads independently from the main body of the mobile platform 106, for example enabling for additional payload capacity and/or facilitating the deployment of payloads during and/or after flight. An anti-theft and/or security system function example includes equipping the stacking spacers 102 and/or the guide element 104 with security features such as, but not limited to, locking mechanisms and/or identification systems, for example to prevent unauthorized removal and/or tampering with the mobile platforms 106 (e.g., during transport, storage, etc.). An example of a visual signal display function includes the equipping the stacking spacers 102 and/or the guide element 104 with visual signaling devices (e.g., LED arrays, flag mounts, etc.), for example which can be used to display operational status, alert signals, other critical information that enhances maneuverability and/or safety in the operational environment, and/or the like. In a data collection integration function example, the stacking spacers 102 and/or the guide element 104 may house data collection devices, such as, but not limited to, cameras and/or data loggers, for example enabling the mobile platforms to collect and/or store information during flights for various applications (e.g., mapping, reconnaissance, research endeavors, etc.).

In operation, in some examples, the stacking spacers 102 remain mounted to the mobile platform 106 as the mobile platform 106 operates (e.g., functions, moves, navigates, flies, drives, glides, rolls, floats, hovers, lands, launches, waits, performs a function and/or action, remains stationary, etc.). For example, in an exemplary implementation, the stacking spacers 102 remain mounted to the mobile platform 106 as the mobile platform 106 performs flight maneuvers. In some examples, a parameter (e.g., a geometry, a material, a size, a density, a weight, etc.) and/or configuration of one or more of the stacking spacers 102 is configured to facilitate movement of the mobile platform 106. For example, a parameter and/or configuration of the stacking spacer 102 may be selected to reduce a weight and/or drag coefficient of the stacking spacer 102, for example to reduce and/or mitigate the effect of the additional mass and/or aerodynamic drag of the stacking spacer 102.

In some implementations, the simultaneous launch of vertically stacked mobile platforms 106 may be facilitated (e.g., assisted, etc.) through the integration of synchronized release mechanisms. A synchronized release system including synchronized release mechanisms is capable of achieving a synchronized release, for example providing simultaneous launch capability for vertically stacked mobile platforms, thereby optimizing their deployment and operational efficiency. Such synchronized release mechanisms include, but are not limited to, coordinated release systems, pyrotechnic separation devices, electromagnetic release mechanisms, mechanical interlock systems, pneumatic liberation systems, hydraulic release systems, and/or the like.

In an example of a coordinated release system, each stacking spacer 102 is equipped with an actuator that releases the mobile platform 106 upon receiving a synchronized signal, which can be transmitted wirelessly and/or via a wired connection (e.g., through the guide element 104. Examples of pyrotechnic separation devices include small pyrotechnic charges strategically placed within each stacking spacer 102. Upon activation, the pyrotechnic charges can break the connections at precisely the same moment, for example allowing all mobile platforms 106 to initiate launch concurrently. Electromagnetic release mechanism examples include, but are not limited to, electromagnets within the stacking spacers 102 to secure the mobile platforms 106 in place, wherein activation of the electromagnets via a simultaneous electrical signal will release all mobile platforms 106 at once.

An example of a mechanical interlock system includes releasing a series of mechanical linkages that hold each mobile platform 106 in place using one or more mechanical actions. For example, pulling a central pin and/or lever connected to interlock mechanisms disengages the mobile platforms 106 simultaneously. In an example of a pneumatic liberation system, pressurized air can be used to create a forceful release of the mobile platforms 106. For example, a system of pneumatic pistons, bladders, and/or the like may simultaneously push each mobile platform 106 out of its stacking spacer 102 upon activation, for example ensuring concurrent deployment. A hydraulic release system example includes employing hydraulic actuators, with a central hydraulic system providing simultaneous release pressure to all mobile platforms 106. The mobile platforms 106, attached via hydraulic couplings, are ejected by synchronized hydraulic force.

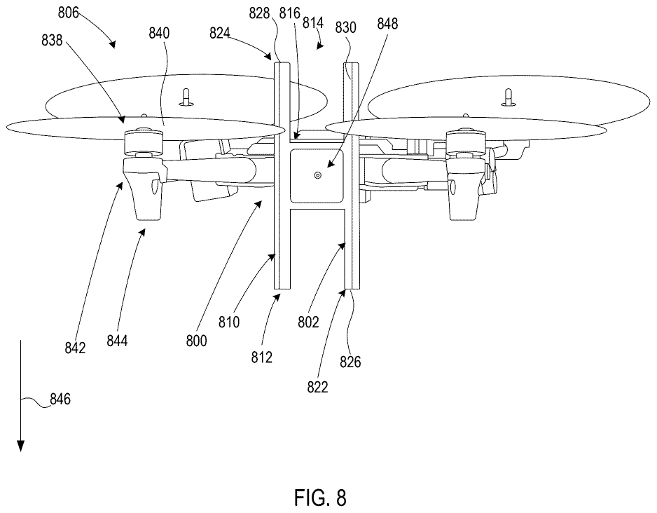

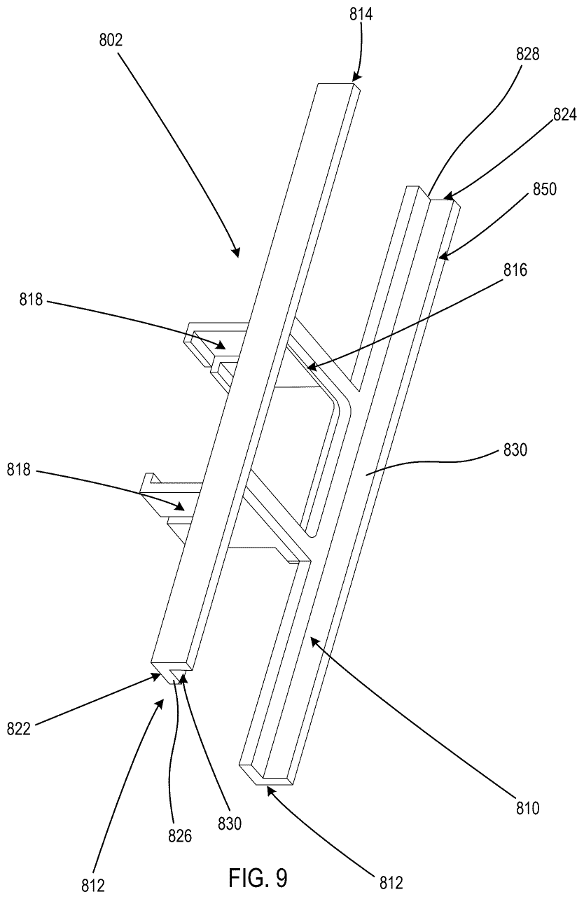

In some examples, for example as is shown in the exemplary implementation of the stacking spacer 102, the body 110 of the stacking spacer 102 defines a leg that is configured to support at least a portion of the corresponding mobile platform 106 when the corresponding mobile platform 106 is at rest. For example, in the exemplary implementation of the mobile platforms 106, the mobile platforms 106 include propeller assemblies 138, with each propeller assembly 138 including a propeller 140 and an accompanying boot 142 positioned beneath the propeller 140. The boots 142 include end portions 144. As best seen in FIGS. 1 and 3, in the exemplary implementation of the stacking spacer 102, the length of the body 110 is selected such that the end portions 112 of the bodies 110 extend further in the direction of the arrow 146 as compared to the end portions 144 of the boots 142. The further extension of the end portions 112 of the bodies 110 as compared to the end portions 144 of the boots 142 configures the bodies 110 of the stacking spacers 102 as legs that are configured to support at least a portion of the corresponding mobile platform 106 when the corresponding mobile platform 106 is at rest on a surface such as, but not limited to, the ground, a floor, a man-made structure, the earth, and/or the like. For example, one or more of the mating features 122 at the end portions 112 of the bodies 110 may be configured to engage in physical contact with the surface on which the corresponding mobile platform 106 rests. In one example, end portions of the extensions 126 are configured to engage in physical contact with the surface on which the corresponding mobile platform 106 rests. In another example, the mating features 122 of the end portions 112 of the bodies 110 include approximately flat end surfaces (e.g., the end surfaces 826 and 828 shown in FIGS. 8 and 9, etc.) that are configured to engage in physical contact with the surface on which the corresponding mobile platform 106 rests.

In some other implementations, the end portions 112 of the bodies 110 extend at approximately the same position along the direction of the arrow 146 as compared to the end portions 144 of the boots 142, such that both the stacking spacers 102 and the boots 142 are configured to support at least a portion of the corresponding mobile platform 106 when the corresponding mobile platform 106 is at rest.

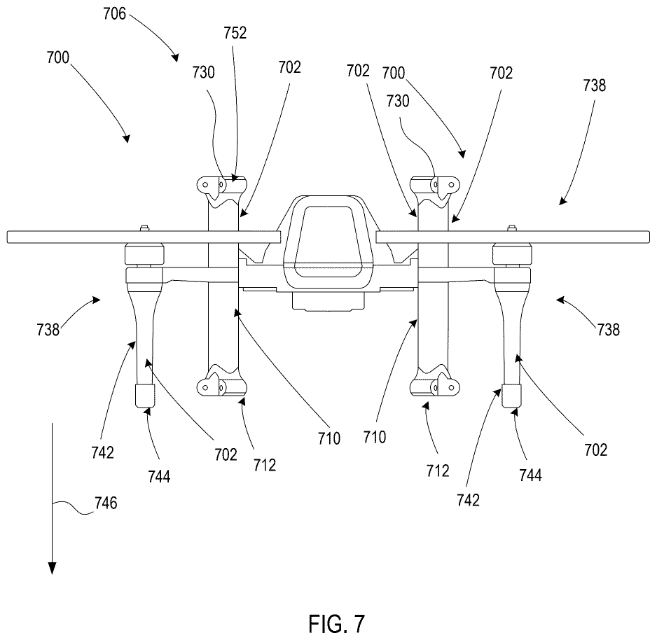

In some other implementations, the length of the body 110 is selected such that the end portions 144 of the boots 142 extend further in the direction of the arrow 146 as compared to the end portions 112 of the bodies 110 of the stacking spacers 102 (e.g., as is shown in FIG. 7, etc.). The further extension of the end portions 144 of the boots 142 as compared to the end portions 112 of the bodies 110 configures the boots 142 as legs that are configured to support at least a portion of the corresponding mobile platform 106 when the corresponding mobile platform 106 is at rest. In some other implementations, a mobile platform 106 includes mix of stacking spacers 102 and boots 142 configured as legs and/or stacking spacers 102 and boots 142 that do not define legs of the mobile platform 106.

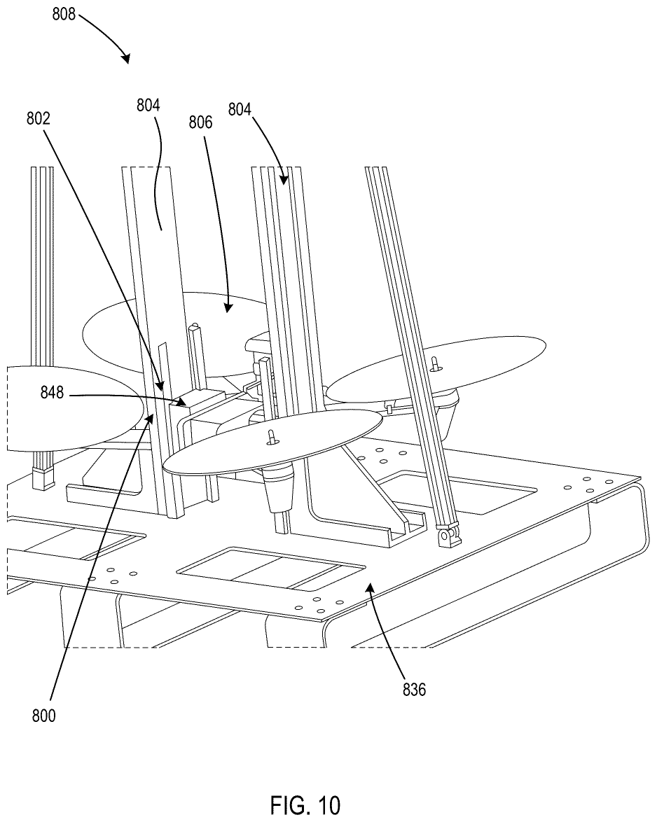

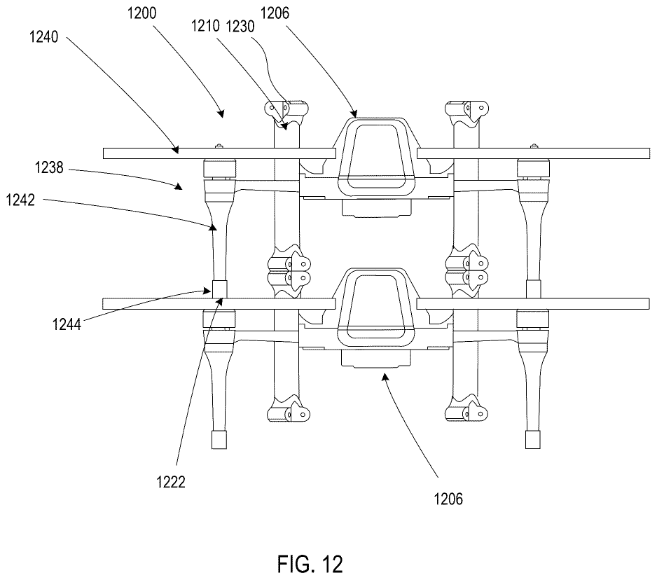

FIG. 7 illustrates an exemplary implementation of a mobile platform 706 wherein boots 742 of propeller assemblies 738 extend further in the direction of the arrow 746 as compared to bodies 710 of the stacking spacers 702. The mobile platform 706 includes a spacer assembly 700 that includes the stacking spacers 702. The stacking spacers 702 include the boots 742 of the propeller assemblies 738 of the mobile platform 706 and the bodies 710. As shown in FIG. 7, the lengths of the boots 742 and the bodies 710 are selected such that end portions 744 of the boots 742 of the stacking spacers 702 extend further in the direction of the arrow 746 as compared to end portions 712 of the bodies 710 of the stacking spacers 702. The further extension of the end portions 744 of the boots 742 as compared to the end portions 712 of the bodies 710 configures the boots 742 as legs that are configured to support at least a portion of the mobile platform 706 when the mobile platform 706 is at rest. In the implementation of FIG. 7, the lengths of the boots 742 of the stacking spacers 702 are configured (e.g., selected, etc.) to space the mobile platform 706 apart from an adjacent mobile platform 706 within a stack (e.g., the stack 108 shown in FIGS. 1-4 and 6, the stack 808 shown in FIG. 10, the stack 1208 shown in FIG. 12, etc.) of the mobile platforms 706, with the bodies 710 of the stacking spacers 702 receiving a guide element (not shown; e.g., the guide element 104, the guide element 804, etc.) therein.

FIG. 8 illustrates another exemplary implementation of a spacer assembly 800 for stacking mobile platforms. The spacer assembly 800 includes stacking spacers 802 and guide elements 804 (shown in FIG. 10). Each stacking spacer 802 is configured to hold (e.g., be mounted to, etc.) a corresponding mobile platform 806 and mate with (e.g., engage in physical contact with, interlock with, etc.) the stacking spacers 802 of adjacent mobile platforms 806 (e.g., above and/or below) within a stack 808 (partially shown in FIG. 10) of the mobile platforms 806. The stacking spacers 802 receive the guide elements 804 therein, for example to facilitate holding the mobile platforms 806 together within the stack 808. The guide elements 804 are configured to provide guiding, stability, and/or alignment functions. For example, each guide element 804 may be configured to: guide the mobile platforms 806 as the mobile platforms deploy (e.g., launch, etc.), provide stability to the mobile platforms 806 within the stack 808, and/or align the positions of the mobile platforms 806 relative to each other within the stack 808. The mobile platform 806 may be referred to herein as a “first”, “second”, and/or a “third” mobile platform.

In some examples, there is one stacking spacer 802 for each mobile platform 806. In other examples, there are two stacking spacers 802 for each mobile platform 806, for example symmetrical on each side of the mobile platform 806. Although two are shown, the stack 808 may include any number of the guide elements 804.

Referring now to FIG. 9, the stacking spacer 802 includes a body 810 extending a length from an end portion 812 to an end portion 814. The length of the body 810 is configured (e.g., selected, etc.) to space the corresponding mobile platform 806 apart from an adjacent mobile platform 806 within the stack 808. In an exemplary implementation, the stack 108 is approximately vertical such that the length of the body 810 spaces the mobile platform 806 apart from an adjacent mobile platform 806 that is positioned above or below the mobile platform 806 within the stack 808. In other implementations, the stack 808 may additionally or alternatively extend approximately horizontal and/or an at oblique angle. Each of the end portion 812 and the end portion 814 may be referred to herein as a “first” and/or a “second” end portion.

The body 810 of the stacking spacer 102 includes a mount 816 that is configured to secure the body 810 to the corresponding mobile platform 806. In an exemplary implementation, the mount 816 includes fingers 818 that are configured to mount to a radio unit 848 (shown in FIGS. 8 and 10) of the mobile platform 806 (shown in FIGS. 8 and 10) with an interference fit and/or snap-fit connection. The mount 816 may additionally or alternatively be configured to mount to the corresponding mobile platform 806 using any other fastener, fit, structure, means, geometry, mechanism, and/or the like, such as, but are not limited to, clips, latches, clamps, c-clamps, bayonet-type fasteners, quarter or half-turn fasteners, springs, spring-loaded fasteners, threaded fasteners, press-fit fasteners, clearance fit fasteners, and/or the like. Although disclosed as being mounted to the radio unit 848, the mount 816 may additionally or alternatively mount to any other component of the corresponding mobile platform 806. The geometry of the mount 816 and the fingers 818 is meant as exemplary and non-limiting. In addition or alternatively to the geometry of the mount 816 and/or the fingers 818 shown and/or described herein, the mount 816 may include any other geometry that enables the mount 816 to function as described and/or illustrated herein. In some examples, the mount 816 include a stamped and/or metal structure. Although two are shown, the mount 816 may include any number of the fingers 818.

Referring now to FIGS. 8-10, the stacking spacer 802 includes mating features 822 and 824. The mating features 822 and 824 are examples of alignment elements that enable the stacking spacers 802 of adjacently stacked mobile platforms 806 to nest together within the stack 808. In an exemplary implementation, the end portion 812 of the body 810 of the stacking spacer 802 includes a mating feature 822 that is configured to mate with the stacking spacer 802 of an adjacent mobile platform 806 within the stack 808. For example, the mating feature 822 at the end portion 812 of the body 810 is configured to mate with the stacking spacer 802 of an adjacent mobile platform 806 (not shown) that is below the mobile platform 806 within the stack 808. The mating feature 822 may be referred to herein as a “first” and/or a “second” mating feature.

In an exemplary implementation, the end portion 814 of the body 810 of the stacking spacer 802 includes a mating feature 824 that is configured to mate with the stacking spacer 802 of an adjacent mobile platform 806 within the stack 808. For example, the mating feature 824 at the end portion 814 of the body 810 is configured to mate with the stacking spacer 802 of an adjacent mobile platform 806 (not shown) that is above the mobile platform 806 within the stack 808. The mating feature 824 may be referred to herein as a “first” and/or a “second” mating feature.

In an exemplary implementation, the mating feature 822 and 824 each include an approximately flat end surface 826 and 828, respectively. The end surface 826 of the mating feature 822 is configured to mate with the end surface 828 of a mating feature 824 of a stacking spacer 802 that corresponds to an adjacent mobile platform 806 within the stack 808 by engaging in physical contact with the end surface 828 of the adjacent mobile platform 806. Similarly, and for example, the end surface 828 of the mating feature 824 is configured to mate with the end surface 826 of a mating feature 822 of a stacking spacer 802 that corresponds to another adjacent mobile platform 806 within the stack 808 by engaging in physical contact with the end surface 826 of the adjacent mobile platform 806.

Each of the mating features 822 and 824 may additionally or alternatively include any other fastener, fit, structure, means, geometry, mechanism, and/or the like that enables the mating features 822 and 824 to mate together. Examples of other fasteners, fits, structures, means, geometries, mechanisms, and/or the like that may be used to mate the mating features 822 and 824 together include, but are not limited to, extensions, openings, clips, latches, clamps, c-clamps, springs, spring-loaded fasteners, and/or the like. The geometries of the end surfaces 826 and 828 are meant as exemplary and non-limiting. In addition or alternatively to the geometry shown and/or described herein, each end surface 826 and 828 may include any other geometry that enables the mating features 822 and 824 to mate together.

The body 810 of the stacking spacer 802 includes a guide opening 830 that extends along the length of the body 810. The guide opening 830 is configured to receive the guide element 804 therein. The guide element 804 extends within the guide openings 830 of the stacking spacers 802 of the mobile platforms 806, for example to facilitate holding the mobile platforms 806 together within the stack 808. For example, the guide element 804 may facilitate aligning the mobile platforms 806 as they are stacked, may facilitate holding the stacked mobile platforms 806 in alignment within the stack 808, may facilitate maintaining the structural integrity and/or stability of the stack 808 of the mobile platforms 806 (e.g., as the stack 808 is stored and/or transported, etc.), may facilitate guiding the mobile platforms 806 during deployment (e.g., launch, etc.), and/or the like. In some examples, the guide element 804 facilitates direct deployment of the mobile platforms 806 from the stack 808. For example, the guide element 804 may facilitate direct deployment by transferring force from a mobile platform 806 to a support surface (e.g., a floor, the ground, etc.) upon which the stack 808 is supported. Optionally, the guide element 804 includes a base 836 (shown in FIG. 10) to increase a stability of the guide element 804. The guide opening 830 illustrates a non-limiting example of a guide segment that receives the guide element 804 therein. In addition or alternative to the disclosed opening, the guide opening 830 may include any other opening geometry and/or any other structure that enables the stacking spacer 802 to function as disclosed herein.

In the exemplary implementation of the stacking spacer 802, the guide opening 830 is defined by an angled segment 850 of the body 810 that receives the guide element 804 therein. Although shown has being rectangular and complementary with the angled segment 850, the guide element 804 may additionally or alternatively include any other shape, for example include a shape that is not complementary with the shape of the guide opening 830. Although shown as approximately 90°, the angled segment 850 may additionally or alternatively include any other angle. Moreover, the guide opening 830 and the angled segment 850 may each additionally or alternatively include any other shape.

In some examples, a parameter (e.g., a geometry, a material, a size, a density, a weight, etc.) and/or configuration of one or more of the stacking spacers 802 and/or the guide element 804 is configured to facilitate the stack 808 being carried by a mobile platform. For example, the guide element 804 may be collapsible (e.g., foldable, telescopically collapsible, etc.) for carrying and/or storage after deployment of the mobile platforms 806. In another example, the geometry of the stacking spacers 802 may be selected such that the stack 808 can be carried and/or otherwise held by a particular mobile platform (e.g., a backpack and/or other carrying pack, a human, an animal, etc.).

In an exemplary implementation, each mobile platform 806 includes two stacking spacers 802 mounted on opposite sides of the mobile platform 806. For example, as is shown in FIG. 10, the mobile platform 806 includes stacking spacers 802 mounted on opposite sides of the mobile platform 806. In some examples, providing two stacking spacers 802 mounted on opposite sides of the corresponding mobile platform 806 facilitates balancing the mobile platform 806, for example during flight and/or other movement. In other examples, one or more mobile platforms 806 includes two stacking spacers 802 mounted on sides that are not opposite each other. Although two are shown and described herein, each mobile platform 806 may include any other number of stacking spacers 802 mounted thereto.

In the exemplary implementation of the stacking spacer 802, the body 810 of the stacking spacer 802 defines legs that are configured to support at least a portion of the corresponding mobile platform 806 when the corresponding mobile platform 806 is at rest. For example, in the exemplary implementation of the mobile platform 806, the mobile platform 806 includes propeller assemblies 838 (not shown in FIG. 9 and not labeled in FIG. 10), with each propeller assembly 838 including a propeller 840 and an accompanying boot 842 positioned beneath the propeller 840. The boots 842 include end portions 844. As best seen in FIG. 8, in the exemplary implementation of the stacking spacer 802, the length of the body 810 is selected such that the end portion 812 of the body 810 extends further in the direction of the arrow 846 as compared to the end portions 844 of the boots 842. The further extension of the end portion 812 of the body 810 as compared to the end portions 844 of the boots 842 configures the body 810 of the stacking spacer 802 as legs that are configured to support at least a portion of the corresponding mobile platform 806 when the corresponding mobile platform 806 is at rest on a surface such as, but not limited to, the ground, a floor, a man-made structure, the earth, and/or the like. For example, the end surfaces 826 of the body 810 are configured to engage in physical contact with the surface on which the corresponding mobile platform 106 rests.

In some other implementations, the end portion 812 of the body 810 extends at approximately the same position along the direction of the arrow 846 as compared to the end portions 844 of the boots 842, such that both the stacking spacers 802 and the boots 842 are configured to support at least a portion of the corresponding mobile platform 806 when the corresponding mobile platform 806 is at rest.

In some other implementations, the length of the body 810 is selected such that the end portions 844 of the boots 842 extend further in the direction of the arrow 846 as compared to the end portion 812 of the body 810 of the stacking spacer 802. The further extension of the end portions 844 of the boots 842 as compared to the end portion 812 of the body 810 configures the boots 842 as legs that are configured to support at least a portion of the corresponding mobile platform 806 when the corresponding mobile platform 806 is at rest. In some other implementations, a mobile platform 806 includes mix of stacking spacers 802 and boots 842 configured as legs and/or stacking spacers 802 and boots 842 that do not define legs of the mobile platform 806.

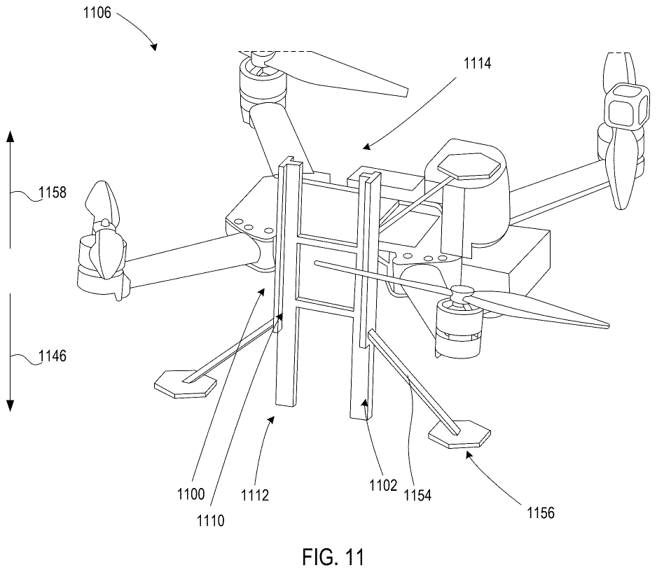

In addition or alternatively to the end portion 812 of the body 810 and/or the end portions 844 of the boots 842, the body 810 includes one or more legs that extend outwardly from the body 810 in the direction 846 and are configured to support at least a portion of the corresponding mobile platform 806 when the corresponding mobile platform 806 is at rest. For example, FIG. 11 illustrates a mobile platform 1106 that includes a spacer assembly 1100 having a stacking spacer 1102 that includes a body 1110 extending a length from an end portion 1112 to an end portion 1114. The body 1110 includes one or more legs 1154 that extends a length outwardly from the body 1110 in the direction of the arrow 1146. The lengths of the legs 1154 are configured such that end portions 1156 of the legs 1154 are configured to support at least a portion of the mobile platform 1106 when the mobile platform 1106 is at rest. Although two are shown, the body 1110 of the stacking spacer 1102 may have any number of legs 1154 (e.g., only a single leg, three legs, etc.) that extend outwardly from the body 1110 in the direction 1146. Optionally, the body 1110 of the stacking spacer 1102 includes one or more legs (not shown) that extends a length outwardly from the body 1110 in the direction of the arrow 1158.

### Additional Implementations

In another implementation, in addition or alternatively to the bodies 110 of the stacking spacers 102, one or more segments (e.g., a payload bracket, a payload arm, a payload holder, a rotor arm, a rotor holder, a leg, a boot, a base, a housing, a skin, a shell, an exterior structure, etc.) of the mobile platform 106 is configured to space the mobile platform 106 from another mobile platform 106 stacked therewith. In some examples, the mating features 122 and 124 and/or the guide opening 130 of the stacking spacers 102 are included within the segment(s) of the mobile platform 106, for example instead of being provided within separate, attachable stacking spacer bodies 110. For example, opposite sides (e.g., opposite end portions, opposite side surfaces, etc.) of the segment of the mobile platform 106 optionally includes the mating features 122 and 124 to enable the mobile platform 106 to mate with adjacent mobile platforms 106 within the stack 108. Optionally, the segment(s) include the guide opening 130. In some examples wherein the segment(s) space the mobile platform 106 from another mobile platform 106 stacked therewith, the bodies 110 of the stacking spacers 102 may not be included (e.g., if the segment(s) include the guide opening 130, etc.).

FIG. 12 illustrates an exemplary implementation wherein a segment 1242 of a mobile platform 1206 is configured to space the mobile platform 1206 from an adjacent mobile platform 1206 stacked therewith. The mobile platforms 1206 include propeller assemblies 1238, with each propeller assembly 1238 including a propeller 1240 and an accompanying boot 1242 positioned beneath the propeller 1240. The boots 1242 include end portions 1244 that enable nesting of the mobile platforms 1206 in the stack 1208. As shown in FIG. 12, the boots 1242 define segments 1242 that space the mobile platform 1206 from the adjacent mobile platform 1206 stacked therewith. For example, the lengths of the boots 1242 are configured (e.g., selected, etc.) to space the corresponding mobile platform 1206 apart from an adjacent mobile platform 1206 within the stack 1208. The exemplary implementation of the mobile platform 1206 thus includes a spacer assembly 1200 that includes the segments 1242 (and optionally stacking spacer bodies 1210). Optionally, each boot 1242 includes a mating feature 1222 for mating (e.g., detachably connecting, etc.) to a top portion of a corresponding propeller assembly 1238 of the adjacent mobile platform 1206 that is underneath the corresponding mobile platform 1206 within the stack 1208.

The mating feature 1222 is configured to enhance the stability of the stacked mobile platforms 1206 during transport and/or to enable the separation of the mobile platforms 1206 for independent launches. In some examples, the mating feature 1222 includes a magnet (not shown) incorporated into the structure of each boot 1242. When the mobile platforms 1206 are stacked, the magnets within the boots 1242 are aligned and secured to the propeller assemblies 1238 of the adjacent mobile platform 1206. In some examples, this magnetic connection ensures that the mobile platforms 1206 remain aligned and stable upon stacking. Any other mating and/or connection mechanisms, geometries, and/or the like that enable nesting, in addition or alternative to magnets, may be used (e.g., any of the other mating features disclosed herein, etc.). For example, the boots 1242 of the mobile platforms 1206 may include recessed contours that correspond to projections on the top surfaces of the propeller assemblies 1238, for example such that the end portions 1244 (e.g., feet, etc.) of the mobile platforms 1206 nest snugly onto the propeller assemblies 1238. This nesting action, combined with the magnetic attraction, facilitates the stackability and stability of the stack 1208 of the mobile platforms 1206.

In the exemplary implementation of the mobile platforms 1206 shown in FIG. 12, the mobile platforms 1206 include stacking spacer bodies 1210 that include guide openings 1230 that receive a guide element (not shown; e.g., the guide element 104, the guide element 804, etc.) therein. In other implementations, the mobile platform 1206 does not include the bodies 1210, for example in implementations wherein the boots 1242 and/or another segment of the mobile platform 1206 includes the guide opening 1230. In addition or alternative to the mating features 1222 on the boots 1242, the bodies 1210 (if included) may include one or more mating features (e.g., the mating features 122, the mating features 124, the mating features 822, the mating features 1222, etc.) for mating with an adjacent mobile platform 1206 within the stack 1208. The guide opening 1230 illustrates a non-limiting example of a guide segment that receives the guide element therein. In addition or alternative to the disclosed opening, the guide opening 1230 may include any other opening geometry and/or any other structure that enables the segment 1242 to function as disclosed herein.

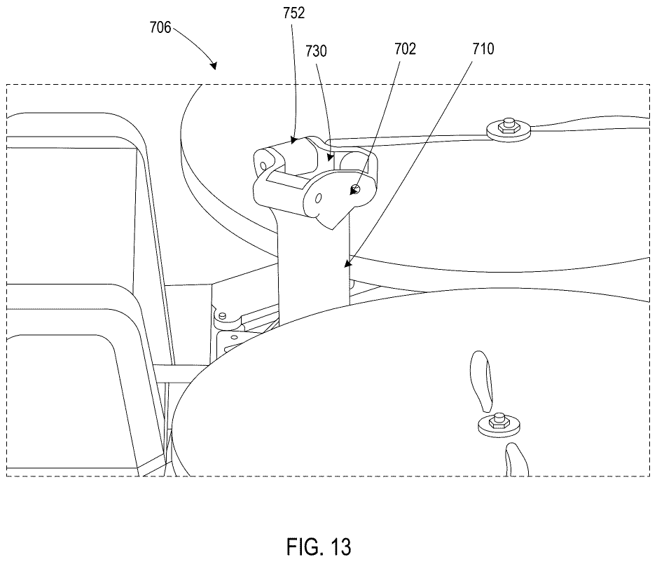

Referring now to FIGS. 7 and 13, in some examples, the bodies 710 of the stacking spacers 702 include rollers 752. The rollers 752 are positioned to engage the guide element as the guide element is received into a guide opening 730 of the body 710. The rollers 752 are configured to reduce the amount of friction and/or stiction experienced by the guide element as the guide element moves through the guide opening. The rollers 752 facilitate stacking of the mobile platforms 706, for example by easing reception of the guide element into the guide opening 730 and easing movement of the guide element along the body 710. The rollers 752 facilitate deployment of the mobile platforms 706, for example by easing movement of the guide element along the body 710 as the mobile platforms 706 are launched from the stack. The guide opening 730 illustrates a non-limiting example of a guide segment that receives the guide element therein. In addition or alternative to the disclosed opening, the guide opening 730 may include any other opening geometry and/or any other structure that enables the stacking spacer 702 to function as disclosed herein.

Referring again to FIGS. 1-3 and 6, in another implementation, the mobile platforms 106 are provided with a pin and socket system. For example, a pin may be located on the top and/or bottom surface of each mobile platform 106, for example for aligning with a corresponding socket on an adjacent mobile platform 106. The pin and socket enable a stable interlocking system, for example maintaining a vertical alignment during transport. In some examples, the pin and socket system includes an automated and/or manually actuated release feature to separate the mobile platforms 106 upon deployment.

Hook and loop fastening strips may be included in addition or alternative to the stacking spacers 102 in some implementations. For example, mobile platforms 106 can be fitted with hook and loop fasteners on their upper and lower surfaces, facilitating the attachment and/or vertical alignment of the mobile platforms 106. Such an arrangement allows for easier stacking and/or securing of the mobile platforms 106 while providing flexibility in removing and launching the mobile platforms individually. The hook and loop fasteners are designed to shear off cleanly upon activation of a release mechanism, for example thus ensuring a smooth detachment for launch.

An interlocking rail and/or groove system is provided in some implementations. For example, each mobile platform 106 may have a set of interlocking rails and/or grooves at top and bottom surfaces thereof, for example allowing adjacent mobile platforms 106 to slide (e.g., horizontally, vertically, etc.) into position (e.g., and lock vertically). The rails and/or grooves provide stability and alignment through mechanical means. For example, the rail and/or groove configuration adheres to set separations effectively aligning mobile platforms 106 for relatively efficient launch without contact. In some examples, a sliding and/or hinge mechanism is provided to facilitate detachment and deployment upon activation.

A slot-based system is another example. For example, a series of approximately parallel slots may be provided on a mounting platform (e.g., on which the stack 108 is mounted, etc.), each slot receiving an individual mobile platform 106. Slots are spaced to maintain horizontal separation, for example ensuring that mobile platforms 106 remain distinct and/or avoid collision during launch.

In another implementation, a strapping system that loops around adjacent mobile platforms 106 can provide stacked alignment. In some examples, straps are made from materials that are tension-adjustable, for example with buckles and/or ratchets to ensure secure stacking. Optionally, upon initiation of launch, the straps can be loosened and/or cut using a quick-release mechanism, for example allowing the mobile platforms 106 to separate and take flight efficiently.

In some examples, a spacer system is provided that includes employing spacer elements of predefined thickness positioned between mobile platforms 106 to maintain an approximately uniform separation, for example during alignment, during transport, to ensure adequate separation for relatively efficient deployment and/or collision avoidance during transport and/or launch, and/or the like. The spacers may be made from relatively lightweight materials and/or be designed to snap onto and/or slide between mobile platforms 106, for example ensuring relatively consistent spacing while providing stability during transport.

In another example, a suspension system is utilized to facilitate separation between adjacent mobile platforms 106. For example, each mobile platform 106 may be attached to a suspension mechanism such as, but not limited to, tensioned cables, elastic bands, and/or the like. Such a suspension system allows mobile platforms 106 to remain suspended at predetermined intervals, for example minimizing contact and/or ensuring individual clearances. The suspension system can provide vertical separation, for example enabling mobile platforms 106 to remain distinct during transit, launch, deployment, and/or the like.

A rotary arm system is another exemplary separation implementation. For example, a rotary arm mechanism may include mobile platforms 106 positioned on rotating arms fixed to a central mounting hub. The arms may extend radially, for example maintaining horizontal separation between mobile platforms 106, and/or allowing for relatively efficient organization. In some examples, upon deployment (e.g., launch, etc.), the arms pivot and/or retract to release the mobile platforms 106 (e.g., sequentially, synchronously, etc.) without interference.

Another implementation includes a telescopic separation system. For example, a telescopic rod configuration may be provided wherein mobile platforms 106 are attached at various segments to provide a scalable means to separate the mobile platforms 106. For example, each segment corresponds to a mobile platform 106 attachment point. As the telescoping rod is extended, mobile platforms 106 are distanced appropriately (e.g., incrementally separated, etc.), for example adequate spacing necessary for ensuring unobstructed launch pathways.

A rack and pinion system is another example. An example of a rack and pinion system involves mounting each mobile platform 106 on an individual platform with rack gears, for example which is movable across the horizontal plane via pinon activation. The platforms can be moved apart by actuating the pinion gears, for example maintaining relatively precise separations, enabling relatively precise control over the separation between mobile platforms 106, ensuring clear launch paths, and/or facilitating controlled deployment.

In some implementations, a guiding and/or stability system integrates a central guiding and/or stability element (e.g., a rod, etc.) with attachment points corresponding to each mobile platform's alignment hole. This allows mobile platforms 106 to be organized along a common axis, for example maintaining vertical separation by segmenting mobile platform 106 placement along the element's length.

### Examples

Aspects of the disclosure include a stacking spacer for a first mobile platform, wherein the stacking spacer includes a body comprising a length extending from a first end to a second end. The length of the body is configured to space the first mobile platform apart from a second mobile platform when the first and second mobile platforms are stacked together. The first end includes a first mating feature that is configured to mate with another stacking spacer of the second mobile platform. The body includes a mount configured to secure the body to the first mobile platform. The body includes a guide opening that extends along the length of the body. The guide opening is configured to receive a guide rod therein.

In some examples, the first mating feature includes an extension that extends outward at the first end and is configured to be received into a mating opening of the other stacking spacer of the second mobile platform.

In some examples, the second end of the body includes a second mating feature that is configured to mate with another stacking spacer of a third mobile platform.

In some examples, the second mating feature includes a mating opening that is configured to receive an extension of the other stacking spacer of the third mobile platform therein.

In some examples, the mount includes a mounting opening configured to receive a fastener therein to secure the body to the first mobile platform.

In some examples, at least one of the first mobile platform or the second mobile platform includes a UAV.

In some examples, the first mobile platform includes a set of propeller assemblies each having a propeller and a boot positioned thereunder. Each boot includes a mating feature for detachably connecting to a top of a corresponding propeller assembly of the second mobile platform. The mating feature facilitates stability of the stack during transport and allows separation of the mobile platforms for individual launch.

In some examples, the mating feature includes a magnet.

Aspects of the disclosure include a first mobile platform that includes a segment extending from a first side to a second side. The segment is configured to space the first mobile platform from a second mobile platform when the first and second mobile platforms are stacked together. The first side includes a first mating feature that is configured to mate with the second mobile platform. The segment includes a guide opening that extends through the segment from the first side to the second side. The guide opening is configured to receive a guide rod therein.

In some examples, the segment includes at least one of a payload bracket, a payload arm, a payload holder, a rotor arm, or a rotor holder.

In some examples, the first mating feature includes an extension that extends outward at the first side and is configured to be received into a mating opening of the second mobile platform.

In some examples, the second side of the body includes a second mating feature that is configured to mate with a third mobile platform.

In some examples, the second mating feature includes an opening that is configured to receive an extension of the third mobile platform therein.

In some examples, at least one of the first mobile platform or the second mobile platform includes a UAV.

Aspects of the disclosure include a stacking spacer for a first mobile platform. The stacking spacer includes a body including a length extending from a first end portion to a second end portion. The length of the body is configured to space the first mobile platform apart from a second mobile platform when the first and second mobile platforms are stacked together. The first end portion includes a first mating feature that is configured to mate with another stacking spacer of the second mobile platform. The body includes a mount configured to secure the body to the first mobile platform. The body includes a guide segment that extends along the length of the body. The guide segment is configured to receive a guide element therein.

In some examples, the mount is configured to secure the body to the first mobile platform such that the body remains mounted to the first mobile platform at least one of: during operation of the first mobile platform; as the first mobile platform performs flight maneuvers; or as the first mobile platform launches.

In some examples, the first mating feature includes an extension that extends outward at the first end portion and is configured to be received into a mating opening of the other stacking spacer of the second mobile platform.

In some examples, the second end portion of the body includes a second mating feature that is configured to mate with another stacking spacer of a third mobile platform.

In some examples, the first mating feature includes an end surface of the body that is configured to engage in physical contact with the other stacking spacer of the second mobile platform.

In some examples, the second end portion of the body includes a second mating feature that is configured to mate with another stacking spacer of a third mobile platform. The second mating feature includes a mating opening that is configured to receive an extension of the other stacking spacer of the third mobile platform therein.

In some examples, the mount includes a mounting opening configured to receive a fastener therein to secure the body to the first mobile platform.

In some examples, the first mobile platform includes a set of propeller assemblies each having a propeller and a boot positioned thereunder. Each boot includes a mating feature for detachably connecting to a top of a corresponding propeller assembly of the second mobile platform.

In some examples, the guide segment includes an opening that extends along the length of the body.

In some examples, at least one of the first mobile platform or the second mobile platform includes at least one of an uncrewed aerial vehicle (UAV) or a rotorcraft.

Aspects of the disclosure include a stacking spacer for a first mobile platform. The stacking spacer includes a body including a guide segment that extends along a length of the body. The guide segment is configured to receive a guide element therein. The body includes a mount configured to secure the body to the first mobile platform. The stacking spacer includes a leg configured to support at least a portion of the first mobile platform when the first mobile platform is at rest. The leg extends a length from a first end portion to a second end portion. The first end portion includes a first mating feature that is configured to mate with a second mobile platform. The length of the leg is configured to space the first mobile platform apart from the second mobile platform when the first and second mobile platforms are stacked together.

In some examples, the mount is configured to secure the body to the first mobile platform such that the body remains mounted to the first mobile platform at least one of: during operation of the first mobile platform; as the first mobile platform performs flight maneuvers; or as the first mobile platform launches.

In some examples, the first mating feature includes at least one of: an extension that extends outward at the first end portion and is configured to be received into a mating opening of the second mobile platform; or an end surface of the body that is configured to engage in physical contact with the second mobile platform.

In some examples, the first end portion of the leg is configured to engage in physical contact with a landing surface.

In some examples, the second end portion of the leg includes a second mating feature that is configured to mate with a third mobile platform.

In some examples, the second end portion of the leg includes a propeller assembly.

In some examples, the guide segment includes an opening that extends along the length of the body.

Aspects of the disclosure include a first mobile platform that includes a segment extending from a first side to a second side. The segment is configured to space the first mobile platform from a second mobile platform when the first and second mobile platforms are stacked together. The first side includes a first mating feature that is configured to mate with the second mobile platform.

In some examples, the segment includes at least one of a payload bracket, a payload arm, a payload holder, a rotor arm, a rotor holder, a leg, a boot, a base, a housing, a skin, a shell, or an exterior structure.

In some examples, the second side of the body includes a second mating feature that is configured to mate with a third mobile platform.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one implementation or may relate to several implementations. The implementations are not limited to those that solve any or all of the stated problems or those that have any or all of the stated benefits and advantages. It will further be understood that reference to ‘an’ item refers to one or more of those items.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements. Any of the functions, operations, and/or the like of the systems, methods, and the like disclosed herein are, in some examples, performed automatically by one or more processors, modules, AI engines, models, and/or the like.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation (e.g., different steps) is within the scope of aspects of the disclosure.

The term “comprising” is used in this specification to mean including the feature(s) or act(s) followed thereafter, without excluding the presence of one or more additional features or acts. The terms “comprising,” “including,” and “having” are intended to be inclusive and mean that there can be additional elements other than the listed elements. In other words, the use of “including,” “comprising,” “having,” “containing,” “involving,” and variations thereof, is meant to encompass the items listed thereafter and additional items. Accordingly, and for example, unless explicitly stated to the contrary, implementations “comprising” or “having” an element or a plurality of elements having a particular property can include additional elements not having that property. Further, references to “one implementation” or “an implementation” are not intended to be interpreted as excluding the existence of additional implementations that also incorporate the recited features. The term “exemplary” is intended to mean “an example of”.

When introducing elements of aspects of the application or the examples thereof, the articles “a,” “an,” “the,” and “said” are intended to mean that there are one or more of the elements. In other words, the indefinite articles “a”, “an”, “the”, and “said” as used in the specification and in the claims, unless clearly indicated to the contrary, should be understood to mean “at least one.” Accordingly, and for example, as used herein, an element or step recited in the singular and preceded by the word “a” or “an” should be understood as not necessarily excluding the plural of the elements or steps.

The phrase “one or more of the following: A, B, and C” means “at least one of A and/or at least one of B and/or at least one of C.” The phrase “and/or”, as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either,” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

It is to be understood that the above description is intended to be illustrative, and not restrictive. For example, the above-described implementations (and/or aspects thereof) can be used in combination with each other. In addition, many modifications can be made to adapt a particular situation or material to the teachings of the various implementations of the application without departing from their scope. While the dimensions and types of materials described herein are intended to define the parameters of the various implementations of the application, the implementations are by no means limiting and are example implementations. Many other implementations will be apparent to those of ordinary skill in the art upon reviewing the above description. The scope of the various implementations of the application should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various implementations of the application, including the best mode, and also to enable any person of ordinary skill in the art to practice the various implementations of the application, including making and using any devices or systems and performing any incorporated methods. The patentable scope of the various implementations of the application is defined by the claims, and can include other examples that occur to those persons of ordinary skill in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A stacking spacer for a first mobile platform, the stacking spacer comprising:
a body comprising a length extending from a first end portion to a second end portion, the length of the body being configured to space the first mobile platform apart from a second mobile platform when the first and second mobile platforms are stacked together;
the first end portion comprising a first mating feature that is configured to mate with another stacking spacer of the second mobile platform;
the body comprising a mount configured to secure the body to the first mobile platform; and
the body comprising a guide segment that extends along the length of the body, the guide segment being configured to receive a guide element therein.

2. The stacking spacer of claim 1, wherein the mount is configured to secure the body to the first mobile platform such that the body remains mounted to the first mobile platform at least one of:
during operation of the first mobile platform;
as the first mobile platform performs flight maneuvers; or
as the first mobile platform launches.

3. The stacking spacer of claim 1, wherein the first mating feature comprises an extension that extends outward at the first end portion and is configured to be received into a mating opening of the other stacking spacer of the second mobile platform.

4. The stacking spacer of claim 1, wherein the second end portion of the body comprises a second mating feature that is configured to mate with another stacking spacer of a third mobile platform.

5. The stacking spacer of claim 1, wherein the first mating feature comprises an end surface of the body that is configured to engage in physical contact with the other stacking spacer of the second mobile platform.

6. The stacking spacer of claim 1, wherein the second end portion of the body comprises a second mating feature that is configured to mate with another stacking spacer of a third mobile platform, wherein the second mating feature comprises a mating opening that is configured to receive an extension of the other stacking spacer of the third mobile platform therein.

7. The stacking spacer of claim 1, wherein the mount comprises a mounting opening configured to receive a fastener therein to secure the body to the first mobile platform.

8. The stacking spacer of claim 1, wherein the first mobile platform comprises a set of propeller assemblies each having a propeller and a boot positioned thereunder, each boot comprising a mating feature for detachably connecting to a top of a corresponding propeller assembly of the second mobile platform.

9. The stacking spacer of claim 1, wherein the guide segment comprises an opening that extends along the length of the body.

10. The stacking spacer of claim 1, wherein at least one of the first mobile platform or the second mobile platform comprises at least one of an uncrewed aerial vehicle (UAV) or a rotorcraft.

11. A stacking spacer for a first mobile platform, the stacking spacer comprising:
a body comprising a guide segment that extends along a length of the body, the guide segment being configured to receive a guide element therein, wherein the body comprises a mount configured to secure the body to the first mobile platform; and
a leg configured to support at least a portion of the first mobile platform when the first mobile platform is at rest, the leg extending a length from a first end portion to a second end portion, the first end portion comprising a first mating feature that is configured to mate with a second mobile platform, wherein the length of the leg is configured to space the first mobile platform apart from the second mobile platform when the first and second mobile platforms are stacked together.

12. The stacking spacer of claim 11, wherein the mount is configured to secure the body to the first mobile platform such that the body remains mounted to the first mobile platform at least one of:
during operation of the first mobile platform;
as the first mobile platform performs flight maneuvers; or
as the first mobile platform launches.

13. The stacking spacer of claim 11, wherein the first mating feature comprises at least one of:
an extension that extends outward at the first end portion and is configured to be received into a mating opening of the second mobile platform; or
an end surface of the body that is configured to engage in physical contact with the second mobile platform.

14. The stacking spacer of claim 11, wherein the first end portion of the leg is configured to engage in physical contact with a landing surface.

15. The stacking spacer of claim 11, wherein the second end portion of the leg comprises a second mating feature that is configured to mate with a third mobile platform.

16. The stacking spacer of claim 11, wherein the second end portion of the leg comprises a propeller assembly.

17. The stacking spacer of claim 11, wherein the guide segment comprises an opening that extends along the length of the body.

18. A first mobile platform comprising:
a segment extending from a first side to a second side, the segment being configured to space the first mobile platform from a second mobile platform when the first and second mobile platforms are stacked together; and
the first side comprising a first mating feature that is configured to mate with the second mobile platform.

19. The first mobile platform of claim 18, wherein the segment comprises at least one of a payload bracket, a payload arm, a payload holder, a rotor arm, a rotor holder, a leg, a boot, a base, a housing, a skin, a shell, or an exterior structure.

20. The first mobile platform of claim 18, wherein the second side of the segment comprises a second mating feature that is configured to mate with a third mobile platform.
